(19) United States
(12) Patent Application Publication
(10) Pub. No.: US 2018/0006676 A1
(43) Pub. Date: Jan. 4, 2018

(54) PROTECTIVE CASE FOR ELECTRONIC DEVICE WITH STORAGE AREA

(71) Applicant: Cesar Zavala, Fontana, CA (US)

(72) Inventor: Cesar Zavala, Fontana, CA (US)

(21) Appl. No.: 15/701,753

(22) Filed: Sep. 12, 2017

Related U.S. Application Data
(63) Continuation-in-part of application No. 14/707,113, filed on May 8, 2015, now abandoned.

(51) Int. Cl. H04B 1/3888; A45C 11/00

(52) U.S. Cl. CPC H04B 1/3888; A45C 2011/002; A45C 2011/003

(57) ABSTRACT

A protective case for electronic devices comprising; a housing having front compartment and a rear surface, wherein the front compartment is sized to securely fit an electronic device, a piece of elastic material secured to rear surface of the housing, wherein at least one edge of the piece of elastic material is unsecured, thereby creating a first compartment, a first portion of a securing means attached to the housing substantially along the secured edges of the piece of elastic material, a pocket having a second compartment having a front surface and a rear surface and a top edge, and a second portion of the attachment means secured to the rear surface to substantially align with the first portion of the attachment means secured to the housing.

### BACKGROUND

The present invention relates generally to the field of protective cases, and more particularly to a protective cover for an electronic device that has a stretchable storage area.

With portable handheld electronic devices (smart phones, media players, and other small personal electronic devices) becoming immensely popular and the expensive of these devices increasing rapidly. The owner's of these devices want to protect them, through the use of protective cases. Many different types of cases have been designed and created to provide the owner with varying degrees of protection and convenience.

One problem the prior art references have attempted to solve is the incorporation of a wallet or pocket in the case. If one wanted to carry their phone and their wallet they would need two different items. This increases the number of such items a person carries around, the greater the likelihood that she will either forget one or more of the items at home, and the greater the likelihood that she will misplace one in a restaurant, bar, office, etc. Some prior art cases combine a portable handheld electronic device protection capability with the personal-item-carrying capability of a wallet.

The issue with these prior art invention is that such prior art offering compartments for carrying personal items are often too bulky to fit easily in a users' pocket. Some prior art cases have rigid compartments integrated into the case, reducing the items which can physically fit within the compartment. Other prior art cases try to allow for larger items to be attached to the phone but they are difficult to use and not secure which results in the person losing their items or having to fumble around with the phone.

Thus, it is desired to have a protective case that has a compartment that is secure, can fit numerous items of varying thickness and shape and be aesthetically pleasing.

### SUMMARY

According to one aspect of the present invention of a protective case for electronic devices comprising; a housing having front compartment and a rear surface, wherein the front compartment is sized to securely fit an electronic device, a piece of elastic material secured to rear surface of the housing, wherein at least one edge of the piece of elastic material is unsecured, thereby creating a first compartment, a first portion of a securing means attached to the housing substantially along the secured edges of the piece of elastic material, a pocket having a second compartment having a front surface and a rear surface and a top edge, and a second portion of the attachment means secured to the rear surface to substantially align with the first portion of the attachment means secured to the housing.

According to another aspect of the present invention, a protective case for electronic devices comprising; a housing having front compartment and a rear surface, wherein the front compartment is sized to securely fit an electronic device, a first piece of material secured to rear surface of the housing, wherein at least one edge of the piece of elastic material is unsecured, thereby creating a first compartment, a second piece of material is secured to the rear surface of the housing above the at least one unsecured edge, a first portion of a securing means attached to the housing substantially along the secured edges of the piece of elastic material, and a pocket having a second compartment and a second portion of the attachment means secured to the pocket to substantially align with the first portion of the attachment means secured to the housing.

### BRIEF DESCRIPTION OF THE SEVERAL VIEWS OF THE DRAWINGS

FIG. 1 depicts a perspective view of a protective case, in accordance with one embodiment of the present invention.

FIG. 2 depicts an exploded view of the protective case, in accordance with an embodiment of the present invention.

FIG. 3 depicts a rear view of a pocket, in accordance with an embodiment of the present invention.

FIG. 4 depicts a front view of a housing, in accordance with an embodiment of the present invention.

FIG. 5 depicts a perspective view of the protective case, in accordance with another embodiment of the present invention.

### DETAILED DESCRIPTION

The present invention relates to a protective case that has a detachable and stretchable compartment on the rear side of the case. This allows the user to have a single item that has their electronic device and their other belongings so there is a lower probability that their items will get lost or misplaced and also allow the user to free up valuable pocket or purse space. The stretchable compartment allows for a greater variety of items which can be help, and the ability to attach and detach the compartment allows the user more freedom to work with. The design shown below provides the user with the opportunity to have one or two compartments attached to their electronic device, this provides more space to carry more materials or items, the ability to separate the items to provide for more organization, and the ability to quickly detach one of these compartments in the event they want to separate the compartments.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein may also be used in the practice or testing of the present invention, the preferred methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

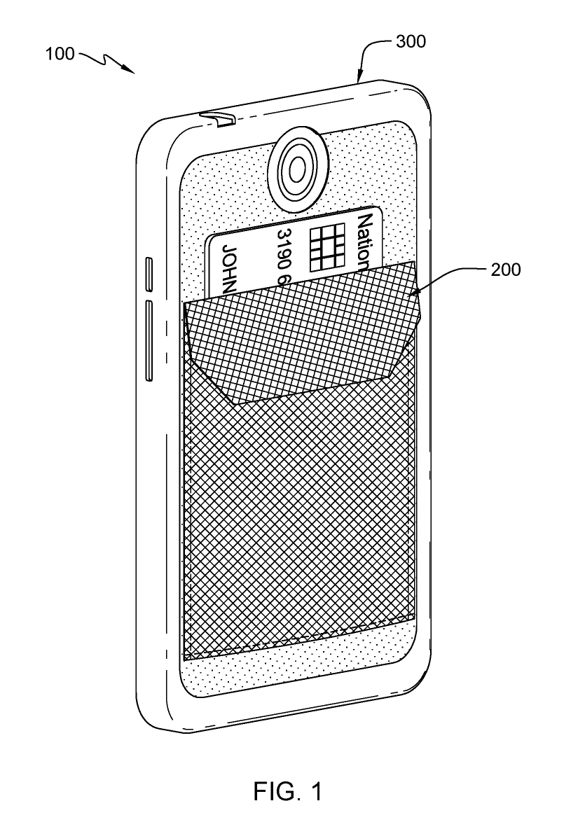

FIG. 1 depicts a perspective view of a protective case 100, in accordance with one embodiment of the present invention. In the depicted embodiment, the protective case 100 is comprised of a pocket 200 and a housing 300. In the depicted embodiment, a credit card (shown) inserted into the pocket in the housing 300 is shown with openings or apertures for various features and functions of the phone (e.g. camera, microphone, buttons, etc.). In some embodiments, there may be additional removable covers for these features and functions. For example, the camera may have a cover that is removable or detachable. In the depicted embodiment, the pocket 200 is temporarily closed.

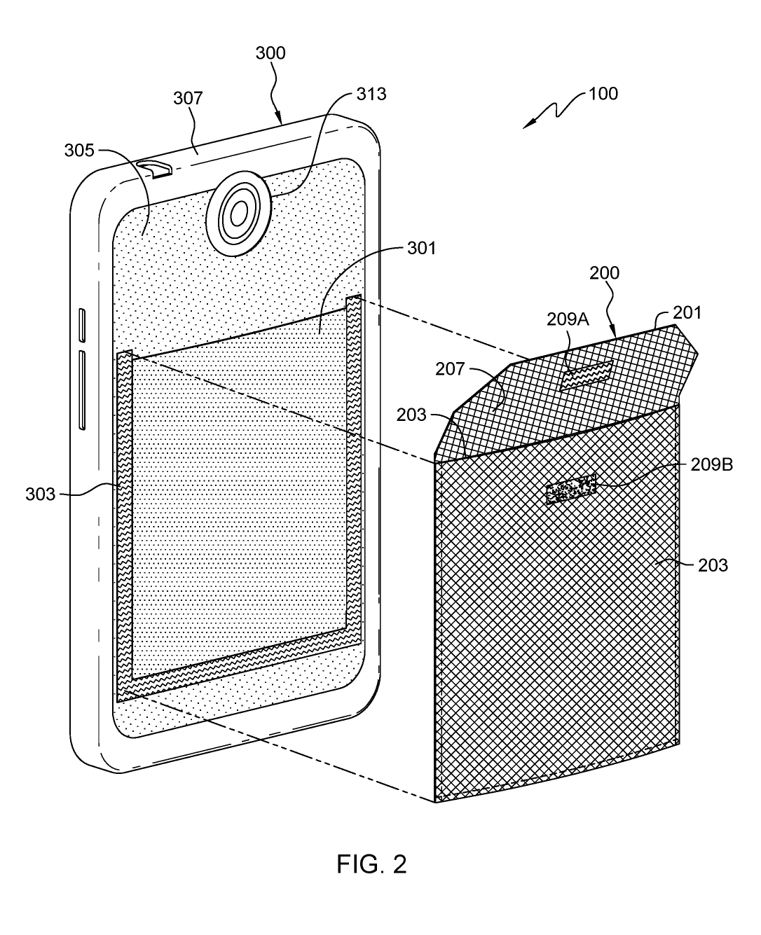

FIG. 2 depicts an exploded view of the protective case 100, in accordance with an embodiment of the present invention. The housing 300 is comprised of an edge guard 307 covering the edge of the electronic device and a back cover 305, which covers the rear surface of the electronic device. The edge guard 307 covers a predetermined surface area of the electronic device, while the back cover 305 covers the remaining exposed surface area of the electronic device on its' rear side. The edge guard 307 and the back cover 305 are secured to one another to create a substantially water tight bond. Based on the electronic device the housing 300 has a predetermined shape designed to securely fit to the electronic device, with predetermined openings and apertures to allow access to the scree, keypad, camera, charging ports, and other inputs (e.g. opening 313 is shown for the camera).

The edge guard 307 may be made from, but not limited to, aluminum, steel, iron, copper, brass, bronze, zinc, stainless steel, polyolefins, styrenics, polypropylene, copolymer polypropylene, polystyrene, thermoplastic elastomers, thermoplastic elastomers, polyethylene, polypropylene, polystyrene, copolymer polypropylene, or the like that are able to be fitted around the electronic device, but also provide protection to the electronic device if dropped or hit against a hard surface. The back cover 305 is made from an elastic material such as various polymers, natural rubber, synthetic rubber, silicone rubber, ethylene vinyl acetate rubber, spandex®, nylon, stretch vinyl and the like. In some embodiments, the sleeve 301 and the back cover 305 are made from the same material and are a unitary element. In some embodiments, the back cover 305 is made from a rigid, or semi-elastic material.

On the rear surface of the housing 300, a sleeve 301 is secured to the back cover 305 and along the exposed edges of the sleeve 301 a plurality of attachment means 303 are secured, covering substantially three sides of the sleeve 301 leaving the top edge of the sleeve 301. In the depicted embodiment, the three sides of the sleeve 301 are substantially covered. In additional embodiments, the bottom side of the sleeve 301 is exposed and the attachment means 303 is secured to the back cover 305 below the bottom of the sleeve 301. The attachment means 303 may be, but not limited to a hook and loop style fastener or various other detachable fasteners known to those skilled in the art. The sleeve 301 may be made from, but not limited to, an elastic material such as various polymers, natural rubber, synthetic rubber, silicone rubber, ethylene vinyl acetate rubber, spandex®, nylon, stretch vinyl and the like.

The pocket 200 is shown having a main body 203 with an opening at the top edge 205, and a flap 201 that covers the opening at the top edge 205. In the shown embodiment, the three sides of the man body 203 expect for the top edge 205 are substantially secured and closed. On the inside surface 207 of the flap 201 a first attachment means 209A is secured in a predetermined location and a second attachment means 209B is secured to the main body 203 in a position that substantially aligns with the first attachment means 209A so that when the flap 201 is closed, the first and second attachment means 209A and 209B mate. The pocket 200 is sized to substantially cover the sleeve 301 of the housing 300, wherein the attachment means 303 substantially aligns with a securing means (not shown) of the pocket 200 to secure the two together. The flap 201 is sized to cover a predetermined portion of the opening so that materials placed inside are unable to fall out.

The first and second attachment means 209A and 209B are mating materials, such as, but not limited to a hook and loop style fastener or various other detachable fasteners known to those skilled in the art. The pocket 200 may be made from, but not limited to, an elastic material such as various polymers, natural rubber, synthetic rubber, silicone rubber, ethylene vinyl acetate rubber, spandex®, nylon, stretch vinyl and the like.

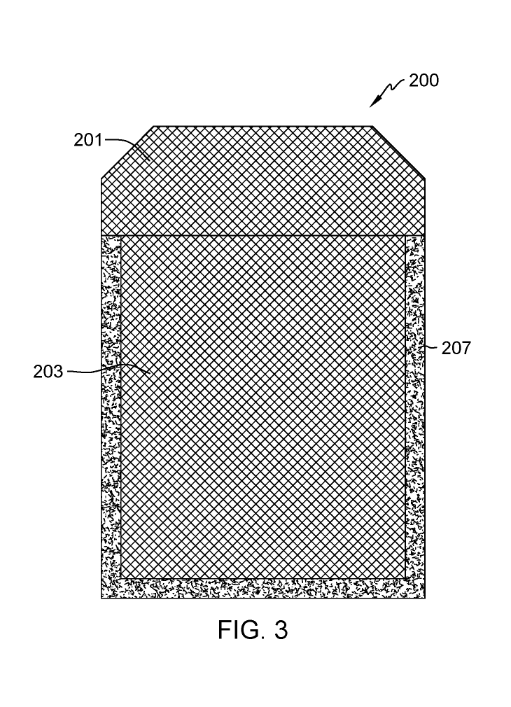

FIG. 3 depicts a rear view of the pocket 200 in the open position, in accordance with an embodiment of the present invention. The securing means 207 is shown on the rear surface 203 of the pocket 200. In the depicted embodiment, the securing means 207 is shown along the edges of the rear surface 203, and this is designed to substantially align with the attachment means 303 of the housing 300. In additional embodiments, the securing means 207 may have different configurations or placements based on the attachment means 303 location and placement. The securing means 207 is shown terminating substantially at the interchange of the top edge and the flap 201. The securing means 207 may be, but not limited to a hook and loop style fastener or various other detachable fasteners known to those skilled in the art.

The pocket 200 may be made from, but not limited to, an elastic material such as various polymers, natural rubber, synthetic rubber, silicone rubber, ethylene vinyl acetate rubber, spandex®, nylon, stretch vinyl and the like.

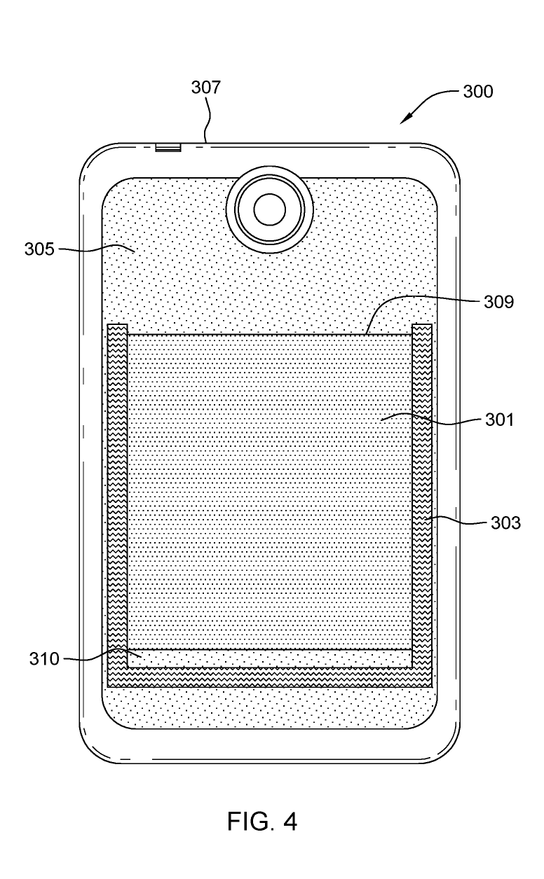

FIG. 4 depicts a front view of the housing 300, in accordance with an embodiment of the present invention. In the depicted embodiment, a gap 310 is present along the bottom edge of the sleeve 301. In the depicted embodiment, the attachment means 303 is shown extending beyond the top edge of the sleeve 301. In various embodiments, the attachment means 303 and the sleeve 301 have predetermined offsets based on the intended amount/quantity of items design to fit within the sleeve.

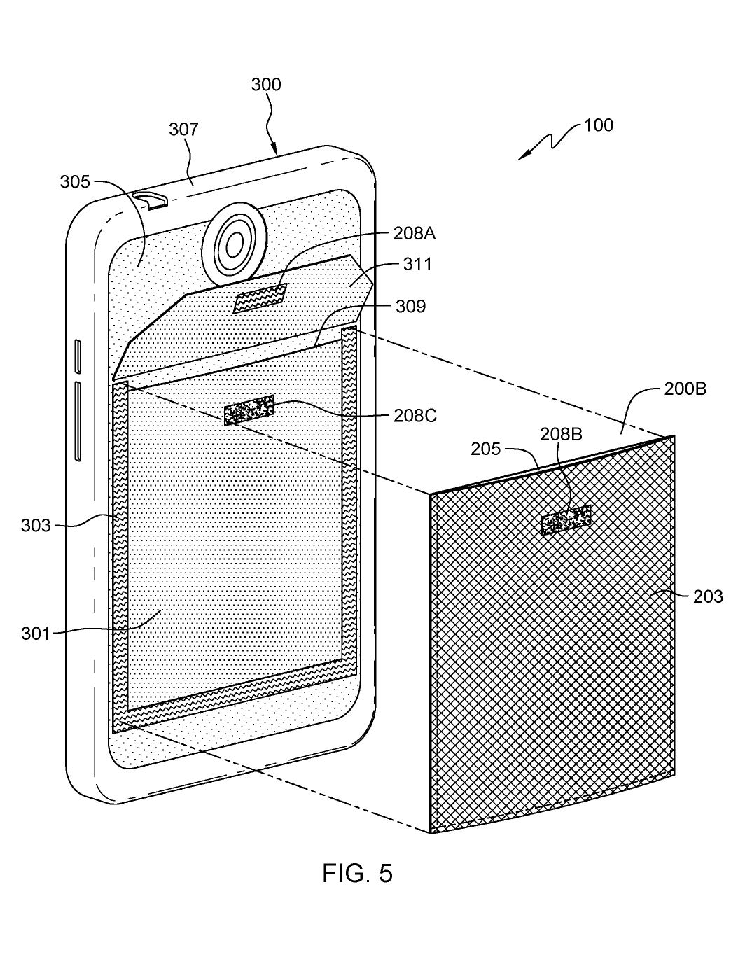

FIG. 5 depicts a perspective view of the protective case 100, in accordance with another embodiment of the present invention. In the depicted embodiment, the pocket 200B has the flap removed, and the flap 311 is attached to the back cover 305 of the housing 300, above the opening to the sleeve 301. The flap 311 has a first locking mechanism 208A, the pocket 200 has a second locking mechanism 208B, and the sleeve 301 has a third locking mechanism 208C. When the pocket 200 is attached, the first and second locking mechanisms can be engaged to secure the contents within the pocket 200 and the sleeve 301. If the pocket 200 is removed, the first and third locking mechanism can be engaged to secure the content of the sleeve 301.

In additional embodiments, various buttons, clasps, clips, and adhesive materials may be used to replace the various attachment means used in the protective cover 100.

In a first embodiment, the sleeve 301 is sized to fit at least one credit card or other card, and the pocket 200 is sized to fit small items such as lip gloss, headphones, keys, or the like. In various embodiments, the size of the sleeve 301 and the pocket 200 may be altered or modified to hold larger items.

The invention is inclusive of combinations of the embodiments or embodiments described herein. References to “a particular embodiment” or “embodiment” and the like refer to features that are present in at least one embodiment of the invention. Separate references to “an embodiment” or “particular embodiments” or “embodiments” or the like do not necessarily refer to the same embodiment or embodiments; however, such embodiments are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention. The present invention shall be easily carried out by an ordinary skilled person in the art, and any modifications and changes are deemed to be within the scope of the present invention.

This written description uses examples to disclose the invention, including the best mode, and also to enable any person skilled in the art to practice embodiments of the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

What is claimed is:

1. A protective case for electronic devices comprising:
a housing having front compartment and a rear surface, wherein the front compartment is sized to securely fit an electronic device;
a piece of elastic material secured to rear surface of the housing, wherein at least one edge of the piece of elastic material is unsecured, thereby creating a first compartment;
a first portion of a securing means attached to the housing substantially along the secured edges of the piece of elastic material;
a pocket having a second compartment having a front surface and a rear surface and a top edge, and a second portion of the attachment means secured to the rear surface to substantially align with the first portion of the attachment means secured to the housing.

2. The protective case of claim 1, wherein the housing further comprises a first portion secured to a second portion, wherein the second portion is a substantial portion of the rear surface of the housing.

3. The protective case of claim 1, wherein the second portion of the housing is made from an elastic material.

4. The protective case of claim 3, wherein the piece of elastic material is secured to the second portion of the housing on two opposing sides.

5. The protective case of claim 4, wherein the first portion of the securing means is secured to the two opposing sides of the piece of elastic material and a predetermined distance from one of the open edges of the piece of elastic material.

6. The protective case of claim 1, wherein the attachment means is a hook and loop style fastener.

7. The protective case of claim 1, wherein the rear surface of the pocket extends a predetermined distance above the top edge and a securing means is positioned on the extended portion of the rear surface and the front surface.

8. The protective case of claim 1, wherein the housing has a plurality of openings to align to allow access to various parts of the electronic device.

9. A protective case for electronic devices comprising:
a housing having front compartment and a rear surface, wherein the front compartment is sized to securely fit an electronic device;
a first piece of material secured to rear surface of the housing, wherein at least one edge of the piece of elastic material is unsecured, thereby creating a first compartment;
a second piece of material is secured to the rear surface of the housing above the at least one unsecured edge;
a first portion of a securing means attached to the housing substantially along the secured edges of the piece of elastic material;
a pocket having a second compartment and a second portion of the attachment means secured to the pocket to substantially align with the first portion of the attachment means secured to the housing.

10. The protective case of claim 9, wherein the housing further comprises a first portion secured to a second portion, wherein the second portion is a substantial portion of the rear surface of the housing.

11. The protective case of claim 9, wherein the second portion of the housing is made from an elastic material.

12. The protective case of claim 11, wherein the piece of elastic material is secured to the second portion of the housing on two opposing sides.

13. The protective case of claim 12, wherein the first portion of the securing means is secured to the two opposing sides of the piece of elastic material and a predetermined distance from one of the open edges of the piece of elastic material.

14. The protective case of claim 9, wherein the attachment means is a hook and loop style fastener.

15. The protective case of claim 9, wherein the rear surface of the pocket extends a predetermined distance above the top edge and a securing means is positioned on the extended portion of the rear surface and the front surface.

16. The protective case of claim 9, wherein a securing means is affixed to the second piece of material and the pocket, wherein when the securing means is engaged both the first compartment and the second compartment are substantially sealed.

17. A protective case for electronic devices comprising:
a housing sized to secure to an electronic device and having a first portion and a second portion, wherein the first portion is made from a substantially rigid material and the second portion is made from a substantially elastic material;
a first portion of material secured to the second portion of the housing;
a second portion of material secured to the second portion of the housing, wherein the second portion of material is first portion of a securing means attached to the housing substantially along the secured edges of the elastic material;
a pocket having a front surface and a rear surface and a top edge, wherein the top edge is open and the rear surface extends a predetermined distance beyond the top edge of the front surface, and the rear surface has a second portion of the attachment means positioned to substantially align with the first portion of the attachment means.
